(19) United States
(12) Patent Application Publication
(10) Pub. No.: US 2008/0170042 A1
(43) Pub. Date: Jul. 17, 2008

(54) Touch signal recognition apparatus and method and medium for the same

(75) Inventors: Soo-yeoun Yoon, Suwon-si (KR); Hyun-jeong Lee, Seoul (KR); Wook Chang, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/896,906

(22) Filed: Sep. 6, 2007

(30) Foreign Application Priority Data
Jan. 17, 2007 (KR) 10-2007-0005352

(51) Int. Cl. G06F 3/041

(52) U.S. Cl. 345/173

(57) ABSTRACT

The present invention a touch signal recognition technology that is capable of filtering a touch signal due to an unintentional touch and effectively detecting a touch signal by an intentional touch to prevent the erroneous operation.

A touch signal recognition apparatus according to an exemplary embodiment of this invention includes a sensing unit sensing a touch signal having a predetermined movement trajectory; a strength recognizing unit recognizing a change in strength of the touch signal; an availability determining unit determining an availability of the touch signal on the basis of the recognized change of the strength; and a controller executing an instruction corresponding to the movement trajectory on the basis of the determined result.

### CROSS-REFERENCE TO RELATED APPLICATIONS

This application claims the priority benefit of Korean Patent Application No. 10-2007-0005352 filed on Jan. 1, 2007 in the Korean Intellectual Property Office, the disclosure of which is incorporated herein by reference in its entirety.

### BACKGROUND OF THE INVENTION

1. Field of the Invention

The present invention relates to touch signal recognition apparatuses and methods and mediums for the same, in particular, to a touch signal recognition apparatus and a method and medium for the same that filters a touch signal due to an unintentional touch and effectively detects a touch signal by an intentional touch to prevent the erroneous operation.

2. Description of the Related Art

A touch screen is an input device that is substituted for input devices such as a mouse or a keyboard, and is applied to a wider field such as a PDA, an LCD, a CRT, banks, public offices, various medical equipment, a guide for tourism and main organization, and a transportation guide.

Touch screens are mainly classified into a resistive touch screen, a surface wave touch screen, and a capacitive touch screen according to the principles of operation. The resistive touch screen senses a change in an electric current on a surface of a touch screen panel, and the surface wave touch screen senses a change in an ultrasonic wave on a surface of a touch screen panel. In contrast, the capacitive touch screen senses a change in a capacitance generated between the touch screen panel and a human body to send to a microprocessor or a microcomputer.

Such touch screens are advantageous in that it allows direct interface, but not advantageous in that they respond to both signals for intentional touch and unintentional touch.

In order to make up for the above disadvantage, an additional key for controlling a sensing function of a touch screen is provided in the touch screen system in the related art. Therefore, when the key is turned off, the sensing function of a touch screen becomes inactivated, thereby reducing an occurrence of an erroneous operation of the touch screen system. However, according to the related art, in order to prevent the erroneous operation of the touch screen, additional key should be mounted as a hardware, and a user needs to manipulate the additional key every time he or she uses the touch screen system, which is inconvenient for the user.

Accordingly, there is a need to provide a touch signal recognition technology that is capable of filtering a touch signal due to an unintentional touch and effectively detecting a touch signal by an intentional touch to prevent an erroneous operation.

### SUMMARY OF THE INVENTION

According to a first aspect of the present invention, there is provided a touch signal recognition apparatus and a method for the same that filters a touch signal due to an unintentional touch and effectively detects a touch signal by an intentional touch to prevent the erroneous operation.

According to a first aspect of the present invention, there is provided a touch signal recognition apparatus including a sensor to sense a touch signal having a predetermined movement trajectory; a strength recognizer to recognize a change in strength of the touch signal; an availability determiner to determine an availability of the touch signal on the basis of the recognized change of the strength; and a controller to execute an instruction corresponding to the movement trajectory on the basis of the determined availability.

According to another aspect of the present invention, there is provided a touch signal recognition method including sensing a touch signal having a predetermined movement trajectory; recognizing a change in strength of the touch signal; determining an availability of the touch signal on the basis of the recognized change of the strength; and executing an instruction corresponding to the movement trajectory on the basis of the determined availability.

According to another aspect of the present invention, there is provided a touch signal recognition apparatus including an availability determiner to determine an availability of a touch signal having a predetermined movement trajectory on the basis of a recognized change of strength of the touch signal; and a controller to execute an instruction corresponding to the movement trajectory on the basis of the determined availability.

According to another aspect of the present invention, there is provided a touch signal recognition method including determining an availability of a touch signal having a movement trajectory on the basis of a recognized change of strength of the touch signal; and executing an instruction corresponding to the movement trajectory on the basis of the determined availability.

According to another aspect of the present invention, there is provided at least one computer readable medium storing computer readable instructions to implement methods of the present invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram showing a configuration of a touch signal recognition apparatus according to an exemplary embodiment of the present invention;

FIG. 2 is a view showing a plurality of capacitive position sensors constituting a sensing unit of FIG. 1;

FIG. 3 is a graph showing a strength measurement result for an arbitrary touch operation;

FIGS. 4 to 6 are views illustrating screens displayed on a display of FIG. 1;

FIG. 7 is a view showing an experimental result that measures a change in strength for a predetermined touch operation;

FIG. 8 is a view showing an experimental result that measures a change in strength for an erroneous operation that may occur in a touch signal recognition apparatus according to an exemplary embodiment of the present invention;

FIG. 9 is a view illustrating a mapping table according to an exemplary embodiment of the present invention; and

FIG. 10 is a flowchart showing a touch signal recognition method according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The present invention may, however, be embodied in many different forms and should not be construed as being limited to exemplary embodiments set forth herein. Rather, these exemplary embodiments are provided so that this disclosure will be thorough and complete and will fully convey the concept of the present invention to those of ordinary skill in the art.

The present invention will be described hereinafter with reference to block diagrams or flowchart illustrations of a touch signal recognition apparatus and method according to an exemplary embodiment thereof. It will be understood that each block of the flowchart illustrations, and combinations of blocks in the flowchart illustrations can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, to implement the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture to implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the block diagrams may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

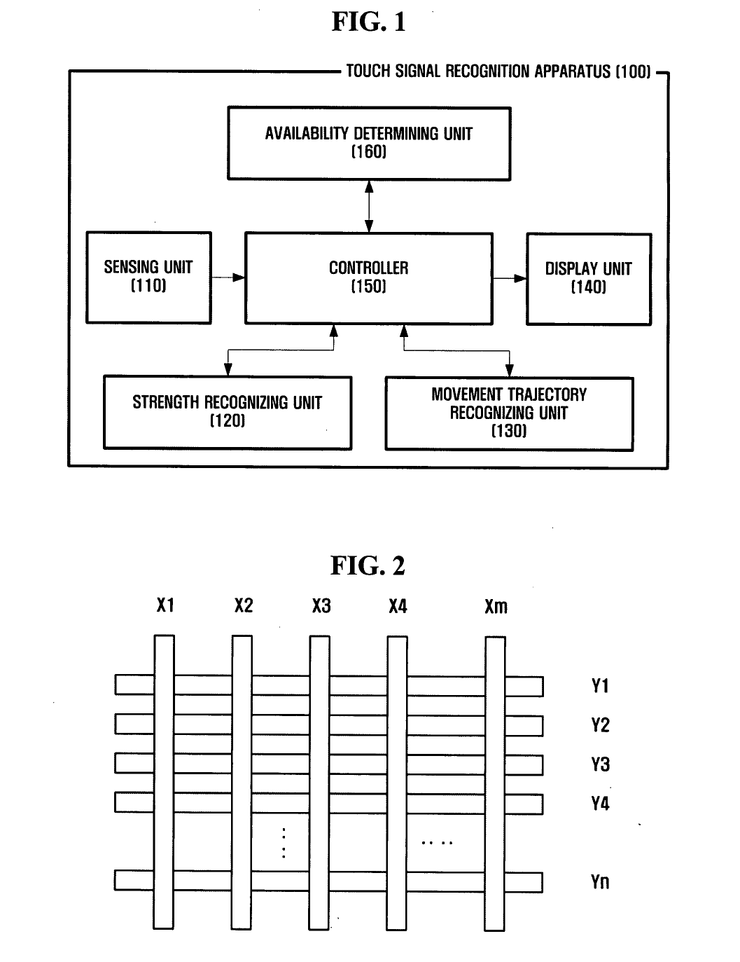

First, a touch signal recognition apparatus according to an exemplary embodiment of this invention will be described with reference to FIGS. 1 to 9.

The touch signal recognition apparatus according to an exemplary embodiment of this invention determines an availability of a touch signal on the basis of a change in strength of the touch signal that has a predetermined movement trajectory, and carries out instructions corresponding to the movement trajectory on the basis of the determined result. Such a touch signal recognition apparatus is a type of digital apparatuses. Here, the digital apparatuses indicate apparatuses including a digital circuit that is capable of processing digital data, for example, PDAs (Personal Digital Assistants), PMPs (Portable Multi Players), portable phones, etc. The touch signal recognition apparatus will be described in detail with reference to FIG. 1.

FIG. 1 is a block diagram showing a configuration of the touch signal recognition apparatus 100 according to an exemplary embodiment of this invention. As shown in FIG. 1, the touch signal recognition apparatus 100 includes a sensing unit 110, a movement trajectory recognizing unit 130, a strength recognizing unit 120, an availability determining unit 160, a controller 150, and a display unit 140.

The sensing unit 110 senses a touch signal generated due to a touch by an object or a human body and sends information regarding a position where a touch signal is sensed and a strength of the touch signal to the movement trajectory recognizing unit 130 and the strength recognizing unit 120 which will be described below. Examples of touch signal sensing methods include a resistive type that senses a change in an electric current due to the touch by an object or a human body, a surface wave type that senses a change in an ultrasonic wave due to the touch by an object or a human body, and a capacitive type that senses a change in a capacitance due to the touch by a human body. In the case of the capacitive type, the sensing unit 110 may be configured by a plurality of capacitive position sensors arranged in a matrix.

FIG. 2 is a view showing an arrangement of the capacitive position sensors. Referring to FIG. 2, the capacitive position sensors are arranged such that m sensing channels in an X-axis direction intersect n sensing channels in a Y-axis direction. The sensing channels arranged in this manner can sense a position where a touch signal is sensed and a strength. A coordinate of the sensed touch signal is represented as (Xᵢ, Yᵢ) and the strength is represented as Sᵢ in the coordinate.

Referring to FIG. 1, the controller 150 determines whether the position of the sensed touch signal is in a touch signal sensing area. The touch signal sensing area is a part of a display area, and may indicate an area where a button or an icon is displayed or a touch signal is sensitive.

If the sensed touch signal is not positioned in the touch signal sensing area, the controller 150 detects a new touch signal that is sensed by the sensing unit 110. In contrast, if the sensed touch signal is positioned in the touch signal sensing area, the controller 150 determines a level of the strength of the sensed touch signal among a plurality of predetermined levels and provides status information for user input with respect to the current strength of the touch signal to a user on the basis of the determined result.

According to this exemplary embodiment, the strength of the touch signal is classified into a first level, a second level, and a third level according to a predetermined reference strength. The first level is the lowest level among the three levels and it is understood that a touch signal having a first level of strength is a signal that is not intended by a user. The second level is higher than the first level, and a touch signal having the second level of strength is a signal that may or may not be intended by the user. The third level is the highest level among the three levels, and a touch signal having the third level of strength is a signal that is intended by the user.

Here, a first reference strength value for distinguishing the first level and the second level, and a second reference strength value for distinguishing the second level and the third level will be described. The first and second reference strength value may be determined through an experimental process. Specifically, a predetermined touch operation is classified into a touch having an intentional input and a touch having no intention input, multiple testers perform the above touch operations for every case. Then, the strength values obtained from the touch operations are analyzed to determine the first reference strength value and the second reference strength value.

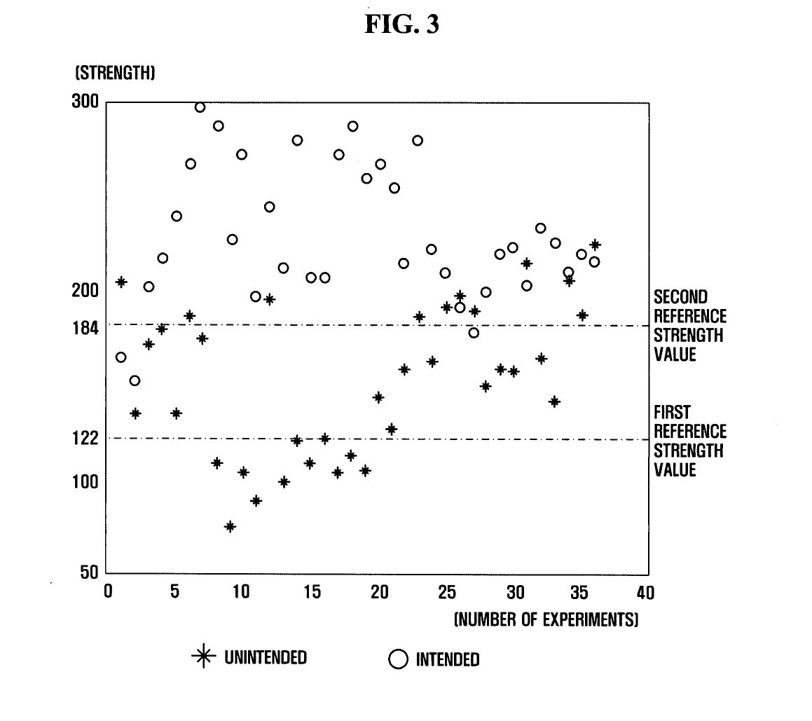

The testers perform an experimental test using both cases of when a touch of a user is intentional or non intentional and a result that measures strength values corresponding to movement trajectories at a starting point is shown in FIG. 3. In FIG. 3, the horizontal axis represents the number of experiments and the vertical axis represents a strength value. In this case, the first and second reference strength values for the touch operation may be determined on the basis of a strength value that is measured when a user has an intention of input. For example, the first reference strength value is set to a value obtained by subtracting a first result value that is obtained by multiplying the minimum measured value by 0.1 from the minimum measured value (for example, 122). Further, the second reference strength value is set to a value obtained by subtracting a second result value that is obtained by multiplying the average measured value by 0.2 from the average measured value (for example, 184). The first and second reference strength value set as described above will be applied in all types of movement trajectories. According to another exemplary embodiment, the first and second reference strength values may be separately applied according to the type of movement trajectory. For example, in the case of a straight line type movement trajectory drawn from the left side to the right side, the first and second reference strength values may be set to 120 and 180, respectively. Further, in the case of a straight line type movement trajectory drawn from the right side to the left side, the first and second reference strength values may be set to 130 and 190, respectively. In this case, the first and second reference strength values are classified according to the types of movement trajectories and stored in a storage unit (which will be described below).

Referring to FIG. 1 again, the controller 150 recognizes the strength of the touch signal to have a plurality of levels, and provides input state information regarding a current strength of the touch signal according to the levels of the strengths of the touch signal to a user.

Specifically, if the strength of the touch signal belongs to the first level, the controller 150 determines that the touch signal is a signal that is not intended by a user, and performs no operation. However, the controller 150 continuously detects new touch signal that is sensed by the sensing unit 110.

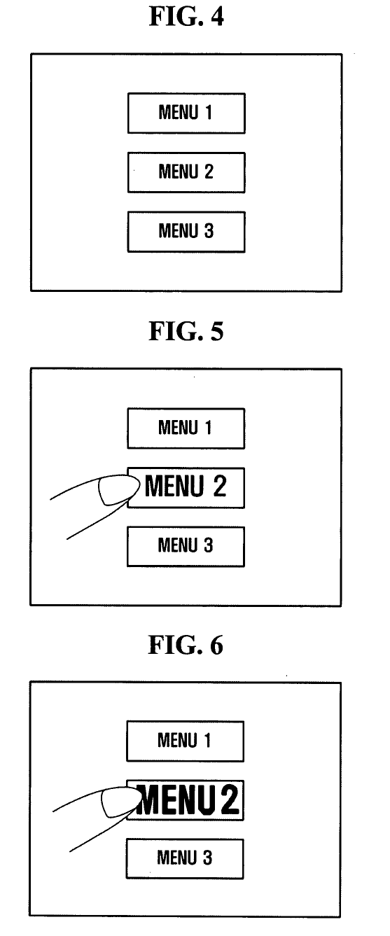

If the strength of the touch signal is within the second level, the controller determines that the touch signal is a signal that may or may not be intended by the user, and informs the user that the current strength corresponds to the second level. For example, in a state shown in FIG. 4, as shown in FIG. 5, the font size of a menu corresponding to a position where a touch signal is sensed is magnified so that the user can see that the current strength of the touch signal corresponds to the second level. Otherwise, by changing the color of characters, it is possible to notify the user that the current strength of the touch signal corresponds to the second level.

If the strength of the touch signal is within the third level, the controller 150 determines that the touch signal is a signal to which that is intended by the user and informs the user that the current strength of the touch signal corresponds to the third level. For example, in a state shown in FIG. 4 or FIG. 5, as shown in FIG. 6, the font size of a menu corresponding to a position where a touch signal is sensed is magnified and the color of the characters is changed so that the user can see that the current strength of the touch signal corresponds to the third level. Then, the controller 150 stores the coordinates and the strengths of the touch signals that are continuously sensed by the sensing unit 110 in the storing unit. When the movement trajectories of the continuously sensed touch signals are analyzed thereafter, the controller 150 can perform instructions corresponding to the movement trajectories.

The strength recognizing unit 120 recognizes the change in strength of the continuously sensed touch signal. For this recognition, the strength recognizing unit 120 calculates a strength change parameter T with respect to the continuously sensed touch signal. Here, the strength change parameter T is defined as a ratio of a total time Tₜₒₜₐₗ when the touch signal is sensed and a time Tₘₐᵢₙ when a strength is constant at the third reference strength value or more, as represented in Equation 1. The strength change parameter T calculated by Equation 1 is provided to an availability determining unit 160 which will be described below.

$$T = \frac{{T}_{main}}{{T}_{total}} \qquad Equation 1$$

Here, the third reference strength value may be determined by an experimental process. Specifically, multiple testers perform a specific touch operation among predetermined touch operations, and the strengths of the touch signals that are continuously input by the touch operation are measured. Thereafter, the third reference strength value may be set to any one of the maximum value, an intermediate value and an average value of the measured values. The third reference strength value may be applied in all of touch operations or separately applied for every touch operation, like the first and second reference strength values.

The availability determining unit 160 determines the availability of the continuously sensed touch signal depending on whether the strength change parameter T sent from the strength recognizing unit 120 exceeds a predetermined threshold value. Specifically, if the strength changes parameter T is less than a predetermined threshold value, the availability determining unit 160 determines that the continuously sensed touch signal is not valid. As a result, the control can detect a new touch signal that is sensed by the sensing unit 110. If the strength change parameter T exceeds a predetermined threshold value, the availability determining unit 160 determines that the continuously sensed touch signal is valid.

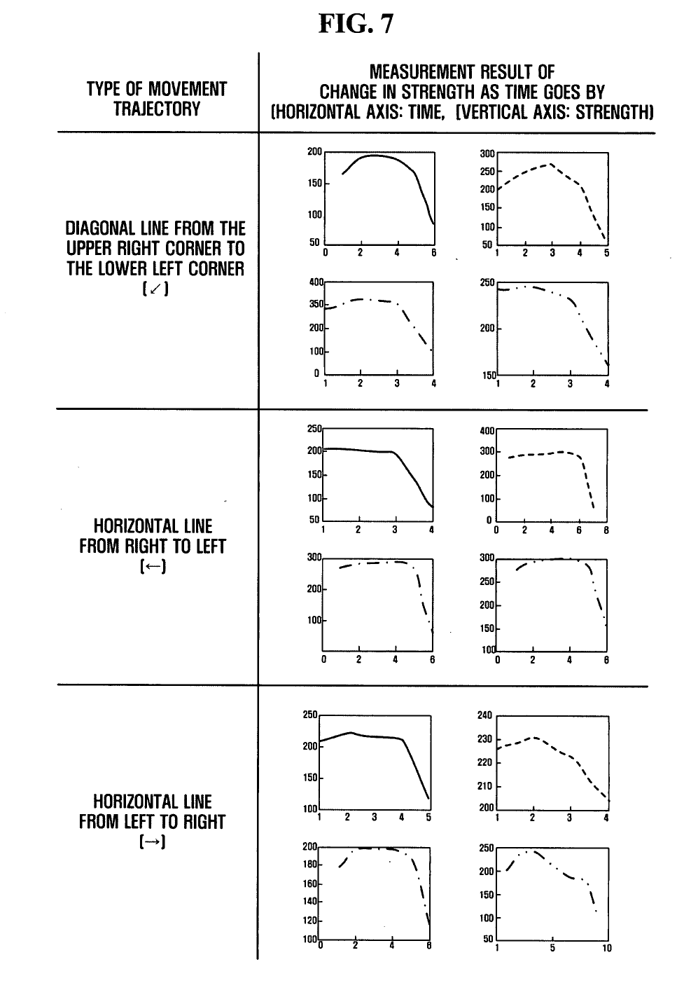

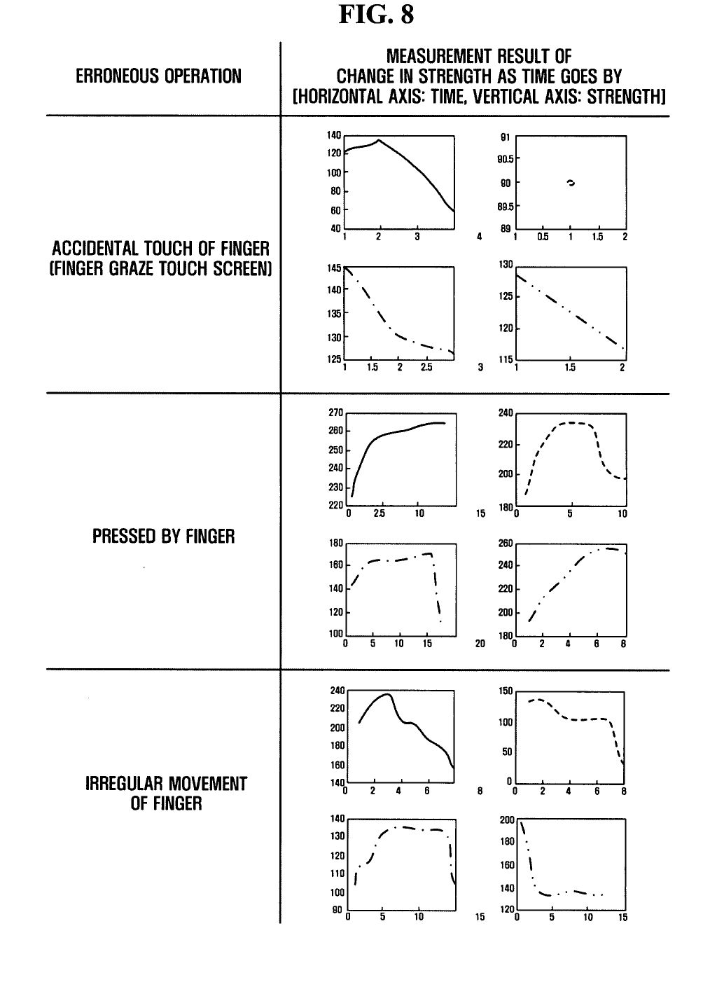

Here, the threshold value may be determined by an experimental process. Specifically, strengths of touch signals that are continuously sensed by a predetermined touch operation and an erroneous touch operation are measured, and then pattern of changes in the measured strength values is analyzed to determine the threshold value. Detailed description will be done with reference to FIGS. 7 and 8.

Four testers perform predetermined touch operations and a result that measures strength values for the touch operations is shown in FIG. 7. Further, four testers also perform erroneous touch operations and a result that measures strength values for the erroneous touch operations is shown in FIG. 8. In FIGS. 7 and 8, the horizontal axis represents a time and the vertical axis represents a strength value. Further, the same kind of line in FIGS. 7 and 8 indicates the results obtained from the same testers.

Referring to FIG. 7, in the case of the predetermined touch operations, it can be understood that the strengths exceed a predetermined level at the starting point, and the strength values form a regular pattern as time goes by. That is, a pattern is formed such that a predetermined level of strength is maintained, but then the level is suddenly decreased. In contrast, referring to FIG. 8, if the case of the wrong touch operation, the strength is very low or high at the starting point, and the strength irregularly changes as time goes by. The threshold value may be determined on the basis of the analyzed result.

Referring to FIG. 1 again, the movement trajectory recognizing unit 130 analyzes the movement trajectory of the continuously sensed touch signal and selects a type corresponding to the analyzed result among predetermined types of movement trajectories to provide the selected value to the controller 150. As a result, the instruction corresponding to the movement trajectory is performed by the controller 150. If there is no type of movement trajectory corresponding to the analyzed result, the movement trajectory recognizing unit 130 informs to the controller 150 that there is no corresponding type of movement trajectory.

Examples of different types of movement trajectories include a diagonal line from the upper right corner to the lower left corner, a horizontal line from left to right, and a horizontal line from right to left, a vertical line from top to bottom, and a vertical line from bottom to top, and each of the types of movement trajectories corresponds to an instruction for performing a predetermined operation.

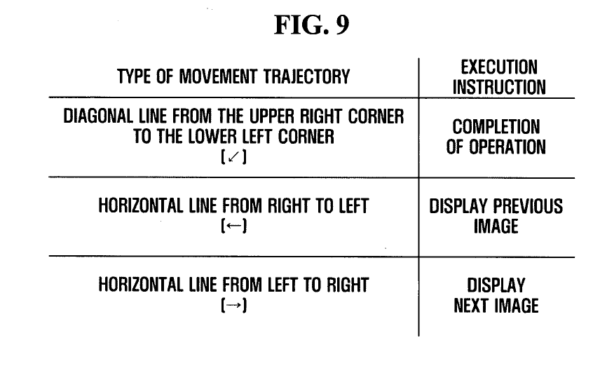

FIG. 9 illustrates a mapping table that represents the correlation between a type of movement trajectory and an instruction corresponding to the type. Referring to FIG. 9, the diagonal line from the upper right corner to the lower left corner corresponds to an instruction that completes an operation that is being performed. The horizontal line from left to right corresponds to an instruction that displays the next image of a currently displayed image, and the horizontal line from right to left corresponds to an instruction that displays the previous image of the currently displayed image. As described above, the instructions corresponding to the types of movement trajectory are instructions for controlling the entire operation or a specific function of the touch signal recognition apparatus 100. For example, the instruction corresponding to the straight line types of the movement trajectory can provide an input method required to execute an electronic book (E-BOOK). Specifically, the horizontal line from left to right corresponds to an instruction that displays the next page of an electronic book that is currently displayed, and the horizontal line from right to left corresponds to an instruction that displays the previous page of an electronic book that is currently displayed. Further, the vertical line from bottom to top and the vertical line from top to bottom correspond to an instruction that scrolls the list of the electronic book upwardly and downwardly, and the diagonal line from the upper right corner to the lower left corner corresponds to an instruction for stopping the electronic book that is currently executed.

Referring to FIG. 1 again, the storing unit stores data sensed by the sensing unit 110, for example, a coordinate of the touch signal and the strength values. Further, the storing unit stores the first reference strength value, the second reference strength value, and the third reference strength value. In this case, the reference strength values may be separately assigned to the touch operations. Further, the storing unit stores information regarding the types of the movement trajectories and the instructions corresponding to the types of the movement trajectories. The storing unit can be embodied in at least one of a non-volatile memory such as an ROM (Read Only Memory), a PROM (Programmable Read Only Memory), an EPROM (Erasable Programmable Read Only Memory), an EEPROM (Electrically Erasable Programmable Read Only Memory), and a flash memory, a volatile memory such as a RAM (Random Access Memory), and a storage medium such as a hard disk, but it is not limited thereto.

The display unit 140 displays the processing result of the instruction. For example, the display unit 140 displays status input information of the strength of the touch signal. The display unit 140 may be embodied to be integrated with the sensing unit 110 as a hardware, and embodied as a display element such as an LCD. However, the display unit 140 is not limited thereto.

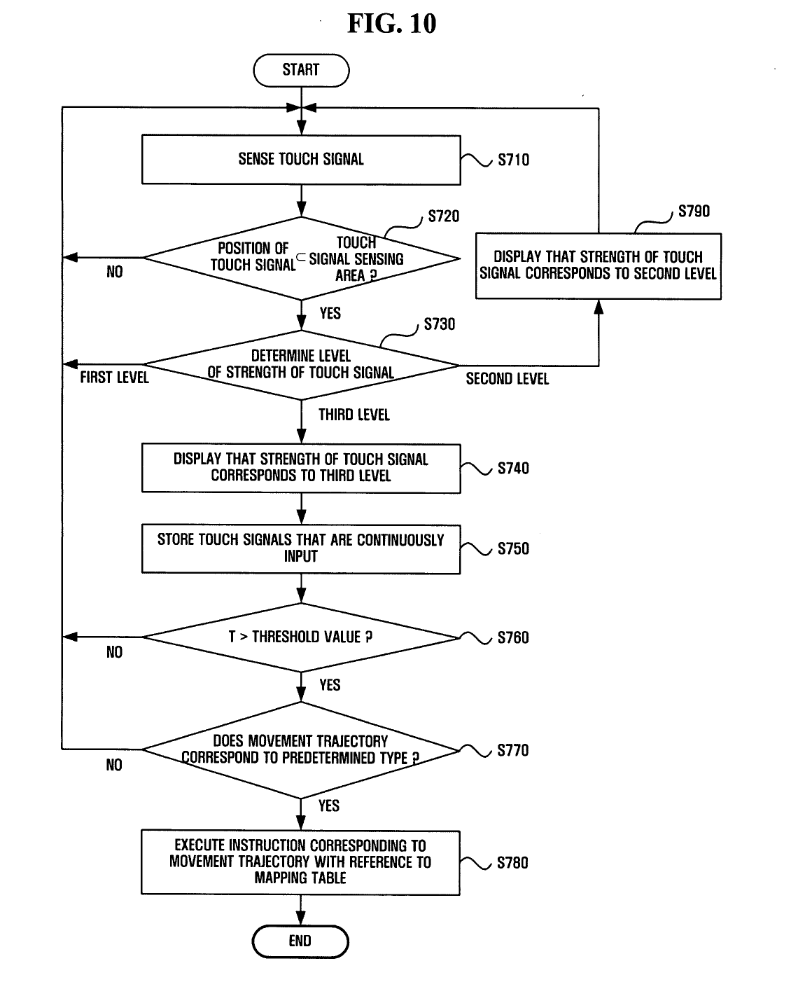

FIG. 10 is a flowchart showing the touch signal recognition method according to another exemplary embodiment of this invention.

First, the sensing unit 110 senses a touch signal generated due to a touch by an object or a human body (S710).

The controller 150 determines whether the coordinate of the sensed touch is positioned in the touch signal sensing area (S720). If the sensed touch signal is not positioned in the touch signal sensing area (S720, No), the controller 150 detects a new touch signal that is sensed by the sensing unit 110. In contrast, if the sensed touch signal is positioned in the touch signal sensing area (S720, Yes), the controller 150 determines the level corresponding to the strength of the touch signal, among a plurality of predetermined levels (S730), and provides status information regarding the current strength of the touch signal to a user on the basis of the determined result.

Specifically, if the strength of the touch signal is within the first level (S730, first level), the controller 150 continuously detects the other touch signal by the sensing unit 110.

If the strength of the touch signal is within the second level (S730, second level), the controller 150 informs user that the current strength of the touch signal corresponds to the second level (S790). For example, in a state shown in FIG. 4, as shown in FIG. 5, the font size of which the user selects a predetermined instruction from a menu is magnified so that the user can see that the current strength of the touch signal corresponds to the second level.

If the strength of the touch signal is within the third level (S730, third level), the controller 150 informs the user that the current strength of the touch signal corresponds to the third level (S740). For example, in a state shown in FIG. 4, as shown in FIG. 6, the font size of which the user selects a predetermined instruction from a menu is magnified and the color of the characters is changed so that the user can see that the current strength of the touch signal corresponds to the third level. Then, the controller 150 stores the coordinates and the strengths of the touch signals that are continuously sensed by the sensing unit 110 (S750).

When the coordinate and the strength values of the touch signals that are continuously input are completely stored, the strength recognizing unit 120 determines whether the change in strength of the stored touch signals matches with the predetermined pattern. Specifically, the strength recognizing unit 120 calculates a parameter that indicates the change in strength of the stored touch signals using Equation 1, and then determines whether the calculated parameter exceeds the predetermined threshold value (S760).

From the determined result, if the calculated parameter does not exceed the threshold value (S760, No), the availability determining unit 160 ignores the stored touch signal and waits the sensing unit 110 to sense a new touch signal.

From the determined result, if the calculated parameter exceeds the threshold value (S760, Yes), the availability determining unit 160 provides the determined result to the movement trajectory recognizing unit 130.

Thereafter, the movement trajectory recognizing unit 130 analyzes the coordinate of the stored touch signal to determine whether the movement trajectory of the touch signal belongs to a predetermined type of a movement trajectory (S770).

From the determined result, if the movement trajectory of the touch signal belongs to a predetermined type of a movement trajectory (S770, Yes), the movement trajectory recognizing unit 130 selects a type corresponding to the analyzed result, and provides the selected value to the controller 150.

Then, the controller 150 executes an instruction corresponding to the movement trajectory of the stored touch signal, with reference to mapping information stored in the storing unit (S780). For example, if the movement trajectory of the stored touch signal corresponds to a diagonal line type from the upper right corner to lower left corner, and the mapping table is the same as shown in FIG. 9, the controller 150 completes the operation that is currently performed. If the movement trajectory of the stored touch signal corresponds to a horizontal line type from left to right and a first image among a plurality of images is displayed in the display unit 140, the controller 150 allows the display unit 140 to display a second image that is the previous image of the first image.

In the meantime, if there is no corresponding type of the movement trajectory to the analyzed result of the movement trajectory recognizing unit, among the predetermined types of the movement trajectories (S770, No), the movement trajectory recognizing unit 130 informs the result to the controller 150. Then, the controller 150 allows the sensing unit to sense new touch signals.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter. In addition, code/instructions may include functional programs and code segments.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, as used herein, denotes, but is not limited to, a software component, a hardware component, a plurality of software components, a plurality of hardware components, a combination of a software component and a hardware component, a combination of a plurality of software components and a hardware component, a combination of a software component and a plurality of hardware components, or a combination of a plurality of software components and a plurality of hardware components, which performs certain tasks. A module may advantageously be configured to reside on the addressable storage medium/media and configured to execute on one or more processors. Thus, a module may include, by way of example, components, such as software components, application specific software components, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s). These hardware components may also be one or more processors.

The computer readable code/instructions and computer readable medium/media may be those specially designed and constructed for the purposes of the present invention, or they may be of the kind well-known and available to those skilled in the art of computer hardware and/or computer software.

As described above, the touch signal recognition apparatus and method and medium according to the present invention have been described with reference to the accompanying drawings, but the present invention is not limited to exemplary embodiments described herein and the drawings. Various modifications can be made by those skilled in the art within the technical scope of the present invention.

Therefore, the touch signal recognition apparatus and method and medium according to an exemplary embodiment of this invention have effects as follows.

It is possible to effectively remove a touch signal due to unintentional touch and effectively detect a touch signal by an intentional touch.

By providing a feedback according to the strengths of the touch signal to a user, it is possible to make the user recognize the appropriate strength required for executing an instruction.

Since input information is received through a touch screen by a simple straight line pattern in addition to a typical click manner, usability can be improved.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A touch signal recognition apparatus comprising:
a sensor to sense a touch signal having a predetermined movement trajectory;
a strength recognizer to recognize a change in strength of the touch signal;
an availability determiner to determine an availability of the touch signal on the basis of the recognized change of the strength; and
a controller to execute an instruction corresponding to the movement trajectory on the basis of the determined availability.

2. The apparatus of claim 1, wherein when the starting point of the movement trajectory belongs to a touch signal sensing area that is a part of a display area, the controller recognizes the strengths of the touch signal to be classified into a plurality of levels.

3. The apparatus of claim 2, further comprising:
a display to display a screen including status information regarding the strength of the touch signal according to the plurality of levels.

4. The apparatus of claim 2, wherein the signal sensing area comprises an area on which a button or an icon is displayed.

5. The apparatus of claim 1, wherein
the strength recognizer calculates a strength change parameter that represents the change in strength of the touch signal, and
the strength change parameter is a ratio of a time when a strength is constant at a first threshold value to a total time when the touch signal is sensed.

6. The apparatus of claim 5, wherein if the ratio exceeds a second threshold value, the availability determiner determines that the sensed signal is valid.

7. The apparatus of claim 1, further comprising:
a movement trajectory recognizer to recognize the movement trajectory.

8. The apparatus of claim 7, wherein, if the recognized movement trajectory corresponds to a predetermined type, the availability determiner determines that the sensed signal is valid.

9. A touch signal recognition method comprising:
sensing a touch signal having a predetermined movement trajectory;
recognizing a change in strength of the touch signal;
determining an availability of the touch signal on the basis of the recognized change of the strength; and
executing an instruction corresponding to the movement trajectory on the basis of the determined availability.

10. The method of claim 9, wherein when the starting point of the movement trajectory belongs to a touch signal sensing area that is a part of a display area, the strengths of the touch signal are recognized to be classified into a plurality of levels.

11. The method of claim 10, further comprising:
displaying a screen including status information regarding the strength of the touch signal according to the plurality of levels.

12. The method of claim 10, wherein the signal sensing area comprises an area on which a button or an icon is displayed.

13. The method of claim 9, wherein:
the recognizing of change in strength of the touch signal comprises calculating a strength change parameter that represents the change in strength of the touch signal, and
the strength change parameter is a ratio of a time when a strength is constant at a first threshold value to a total time when the touch signal is sensed.

14. The method of claim 13, wherein the determining of the availability of the touch signal comprises, if the ratio exceeds a second threshold value, determining that the sensed signal is valid.

15. The method of claim 9, further comprising:
recognizing the movement trajectory.

16. The method of claim 15, wherein the determining of the availability of the touch signal comprises, if the recognized movement trajectory corresponds to a predetermined type, determining that the sensed signal is valid.

17. At least one computer readable medium storing computer readable instructions that control at least one processor to implement the method of claim 9.

18. A touch signal recognition apparatus comprising:
an availability determiner to determine an availability of a touch signal having a predetermined movement trajectory on the basis of a recognized change of strength of the touch signal; and
a controller to execute an instruction corresponding to the movement trajectory on the basis of the determined availability.

19. A touch signal recognition method comprising:
determining an availability of a touch signal having a movement trajectory on the basis of a recognized change of strength of the touch signal; and
executing an instruction corresponding to the movement trajectory on the basis of the determined availability.

20. At least one computer readable medium storing computer readable instructions that control at least one processor to implement the method of claim 19.
